(19) United States
(12) Patent Application Publication
(10) Pub. No.: US 2007/0089238 A1
(43) Pub. Date: Apr. 26, 2007

(54) Multipositional bariatric bed

(75) Inventors: DuWayne E. Kramer, Lake Quivira, KS (US); Brian W. Mellies, Stillwell, KS (US)

Correspondence Address: BLACKWELL SANDERS PEPER MARTIN LLP, 4801 Main Street, Suite 1000, KANSAS CITY, MO, 64112, US

(73) Assignee: Leisure-Lift, Inc.

(21) Appl. No.: 11/258,768

(22) Filed: Oct. 26, 2005

(51) Int. Cl. A61G 7/015

(52) U.S. Cl. 5/618

(57) ABSTRACT

A multipositional bariatric bed is provided. In particular, the present invention includes an articulating head support for raising and lowering a bariatric patent's head and upper torso, an articulating seat support for raising and lowering a bariatric patient's lower torso and upper legs, and an articulating foot support for raising and lowering a bariatric patient's feet. The multipositional bed of the present invention provides ease of maneuverability in allowing a patient to be raised to a sitting and then standing position with little to no assistance from another person.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

In recent years, the health care industry has become more aware of the needs that larger-sized patients have during hospitalization and other long term care stays. Those patients that exceed a certain weight and body mass index (BMI), typically 400 pounds and a BMI of 40, are referred to as “bariatric” patients. Bariatric patients often suffer from health ailments related to being bedridden for extended periods of time, such as skin conditions and poor blood circulation. Additionally, bariatric patients are often difficult for health care providers or workers to physically lift and position because of their size. Injuries are common among nurses and nurse assistants working with these types of patients, and it is estimated that a single back injury to a provider costs the health care industry between $15,000 and $18,000.

To address these issues, special equipment has been devised for moving bariatric patients from place to place, and also to serve as their bed in health care facilities. A portable bariatric bed resting on a number of wheels is one such device, combining a mattress system configured to facilitate air circulation beneath the patient with an articulating frame that can be adjusted to a number of positions beneficial to moving the position of the patient on the mattress, as well as moving them into and out of the bed.

While advances have been made in bariatric bed design, significant problems still exist with enabling a patient to independently sit up in bed or stand without the need for health care workers to bear the weight of the patient in order to assist the patient in such maneuvers. For instance, if a bariatric patient in currently-available bariatric beds wished to visit the bathroom, one or more nurses or nurse assistants would be required to assist the patient into a standing position. These health care workers may excessively strain themselves in attempting to bear the patient's weight in order to maneuver the patient into a standing position. Similarly, if a patient wished to sit up, one or more health care workers would be needed to lift the patient into a sitting position thereby putting such workers at risk for physical injuries, some of which could be career ending.

Moreover, transporting the patient while still in the bariatric bed without excessive strain to the health care worker poses a significant problem. Due to the sheer size of bariatric beds and the combined weight of both the bed and the patient (sometimes exceeding 1600 pounds), most health care workers find it difficult to push and steer these beds in a desired direction of travel. For instance, if a worker were pushing a loaded bariatric transport down a hallway and wished to turn right or left into a room, the inertia of the bed would make it difficult to slow down the speed of the bed and initiate rotation into a doorway. The need to transport patients on such beds quickly and safely is even more acute in an emergency evacuation situation (e.g., fire, tornado, terrorism threat), where a finite number of workers must move a set number of patients into a safe area of a building or completely out of a building. With bariatric patients, as many as 5 or 6 workers may be required to maneuver the loaded bed, compromising their ability to care for other patients in need. Difficulties also arise in situations where a bed needs to be rotated in place without moving laterally too much in any direction (e.g., within a patient's room). Workers will often find that it is difficult to gauge and control whether the bed is actually rotating in place or “wandering” toward a wall, medical equipment, or other hazards.

Some portable hospital beds include a propulsion system for aiding a worker in moving the bed. However, existing powered bed designs are frequently complicated and often cannot be used to actually drive and steer the bed. Furthermore, such beds often lack an operator friendly control system for directing the bed in a desired movement pattern.

### BRIEF SUMMARY OF THE INVENTION

A multipositional bariatric bed adapted for supporting a patient thereon is provided that includes a base frame having a forward portion, a center portion, and a back portion; an articulating head support pivotably coupled to and overlying the back portion of the base frame and extending generally toward a back end of the transport away from the center portion of the base frame and a free end configured to move generally vertically relative to the base frame in at least one pivoted position of the head support, the head support having a first surface formed thereon; an articulating seat support overlying the center portion and pivotably coupled to a front end of the center portion of the base frame and extending generally toward a back end of the center portion and a free end moving configured to move generally vertically relative to the base frame in at least one pivoted position of the seat support, the seat support having a second surface formed thereon; an articulating foot support overlying the forward portion of the base frame and pivotally coupled to a back end of the forward portion and extending generally toward the front end of the forward portion and a free end configured to move downwardly relative to the base frame in at least one pivoted position of the articulating foot support, the articulating foot support having a third surface formed thereon; a first actuator for pivoting the head support relative to the base frame; a second actuator for pivoting the seat support relative to the base frame; and a third actuator for pivoting the foot support relative to the base frame; wherein the first, second and third surfaces are adapted to support a patient thereon.

### BRIEF DESCRIPTION OF THE SEVERAL VIEWS OF THE DRAWING

In the accompanying drawings which form a part of the specification and which are to be read in conjunction therewith and in which like reference numerals are used to indicate like parts in the various views:

FIG. 1 is a side perspective view of a multipositional bariatric bed in accordance with one embodiment of the present invention;

FIG. 2 is a side elevational view of a multipositional bariatric bed in accordance with one embodiment of the present invention;

FIG. 3. is a side elevational view of a multipositional bariatric bed in accordance with one embodiment of the present invention;

FIG. 4 is a partial side elevational view of a multipositional bariatric bed in accordance with one embodiment of the present invention;

FIG. 5 is a partial side elevational view of a multipositional bariatric bed in accordance with one embodiment of the present invention;

FIG. 6 is a partial side elevational view of a multipositional bariatric bed in accordance with one embodiment of the present invention;

FIG. 7 is a partial side elevational view of the multipositional bariatric bed of FIG. 6 with the foot support in a lowered position;

FIG. 8 is a partial side elevational view of the multipositional bariatric bed of FIG. 6 with the foot support in a raised position;

FIG. 9 is a side elevational view of a multipositional bariatric bed in a reverse Trendelenberg position in accordance with one embodiment of the present invention;

FIG. 10 is a side elevational view of the multipositional bariatric bed in accordance with one embodiment of the present invention in a fully raised position;

FIG. 11 is a partial side elevational view of the seat support in a raised position in accordance with one embodiment of the present invention;

FIG. 12 is a partial side elevational view of the patent support assembly in a raised position with the foot support in a lowered position in accordance with one embodiment of the present invention;

FIG. 13 is a partial side elevational view of the patient support assembly in a lowered position with the foot support in a lowered position in accordance with one embodiment of the present invention;

FIG. 14 is a top plan view of a multipositional bariatric bed in accordance with one embodiment of the present invention;

FIG. 15 is a top perspective view of the head support with head support extensions in accordance with one embodiment of the present invention; and

FIG. 16 is a rear perspective view of the mounting apparatus in accordance with one embodiment of the present invention.

### DETAILED DESCRIPTION OF THE INVENTION

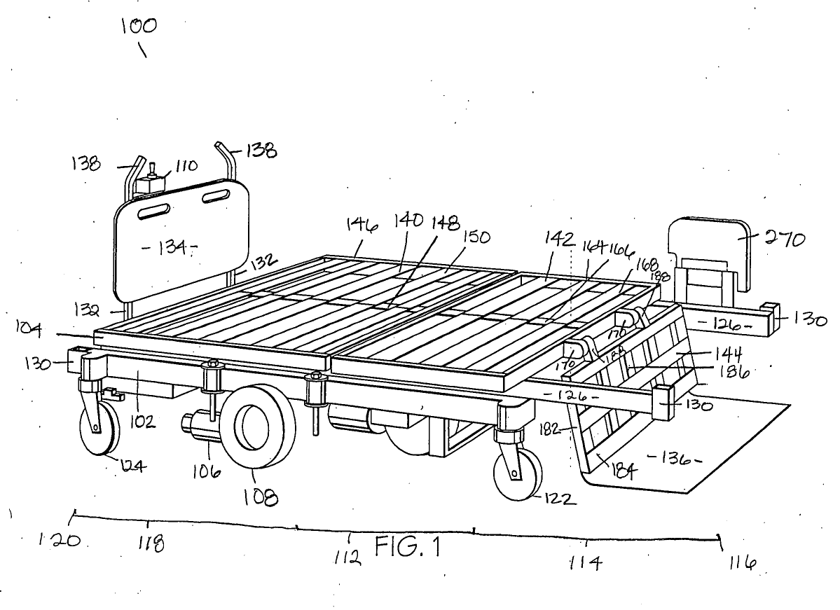

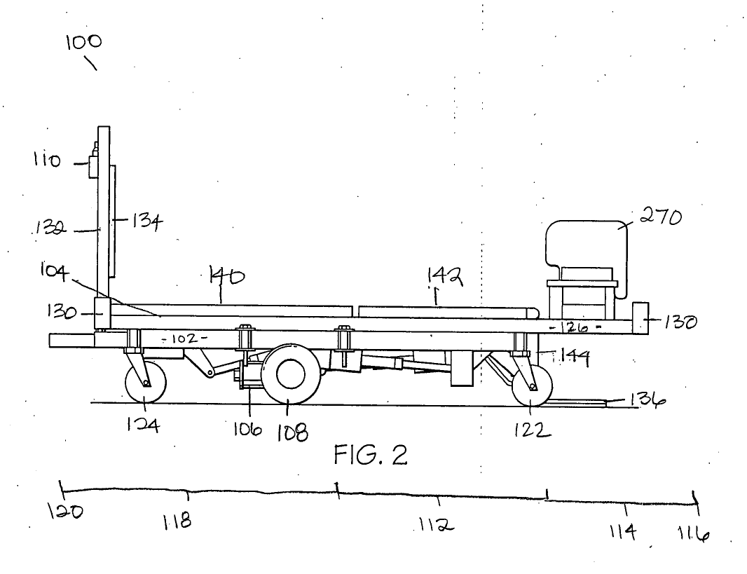

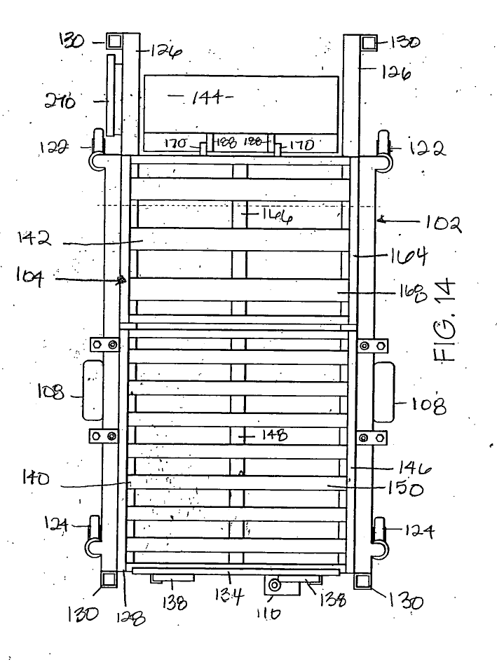

Referring now to the drawings in greater detail, and initially to FIGS. 1, 2 and 14, one embodiment of a multipositional bariatric bed for accommodating an obese person is represented by the reference numeral 100. The bariatric bed 100 includes generally a base frame 102, a patient support assembly 104 mounted onto the base frame 102, a drive assembly 106 having a pair of drive wheels 108 for propelling the bed 100 in a variety of movement patterns, and a control system 110 directing operation of the drive assembly 106 according to user selections.

The base frame 102 of the bed 100 includes a center portion 112, a forward portion 114 extending from the center portion 112 to a forward end 116, and a back or aft portion 118 extending from the center portion 112 to a back end 120 in the opposite direction of the forward end 116. A central longitudinal axis of the bed 100 bisects the base frame 102 and may be used for positioning of the drive assembly 106, as will be discussed in further detail below. As used herein the terms “forward” and “back” are used in reference to the vantage point of the operator who is guiding the bed 100 in a direction of travel. Thus, what is typically called the “foot” of the transport is considered the forward or leading end 1 16 of the bed 100, and what is called the “head” of the transport is considered the back or trailing end 120 of the bed 100.

Leading stabilizing wheels 122 and trailing stabilizing wheels 124 provide support and balance the bed 100 on an underlying surface (e.g., a floor) when the drive assembly is in operation and serve as the means to allow movement of the bed 100 across the underlying surface manually when the drive wheels 108 are not engaging the surface. A number of actuators described below that are mounted on the base frame 102 perform the functions of manipulating the position of the various components of the patient support assembly 104 as well as raising and lowering the patient support assembly 104 relative to the base frame 102 and the underlying surface on which the bed 100 is resting as will be discussed in further detail below with references to additional figures. Thus, the actuators facilitate positioning of a patient in an orientation desired by the operator (e.g., Trendelenberg position or reverse Trendelenberg position) of the bed 100. The actuators are preferably linear actuators such as motor driven screws or rotary actuators as described in more detail herein.

The patient support assembly 104 overlying base frame center portion 112, forward portion 114 and back or rear portion 118 is formed of spaced longitudinal members 126 and a longitudinally spaced transverse member 128 affixed together on ends thereof at back end 120. The transverse member 128 of the back portion 118 may also have a first set of sleeves 130 with a solid bottom for removable insertion of risers 132 to hold the same in position. Each of the spaced longitudinal members 126 may also have a set of sleeves affixed to the forward end 116 thereof for removable insertion of risers 132 to hold the same in position. Transverse member 128 may also have a second set of sleeves 130 with a solid bottom for removable insertion of a second set of risers 132 that may have a headboard 134 affixed thereto. Further, a footplate 136 may also be mounted or affixed to forward end 116. A pair of risers 132 may also extend upwardly from either or both of the forward end 116 and back end 120 of the base frame 102 and/or patient support assembly 104 and curve inwardly towards one another to define a set of handles 138 at terminal ends of the risers 132. In a preferred embodiment, handles 138 are integral with the second set of risers 132 and extend beyond headboard 134. The handles 138 may be at various orientations, e.g., inclined, horizontal, or vertical.

The patient support assembly 104 includes an articulating head or upper body support 140 generally overlying the back portion 118 of the base frame 102, an articulating seat support or gatch 142 generally overlying the center portion 112 of the base frame 102, and an articulating foot or lower body support or gatch 144 generally overlying the forward portion 114 of the base frame 102. The head support 140, seat support 142 and foot support 144 combine to provide a surface upon which a mattress may be placed for support of a patient.

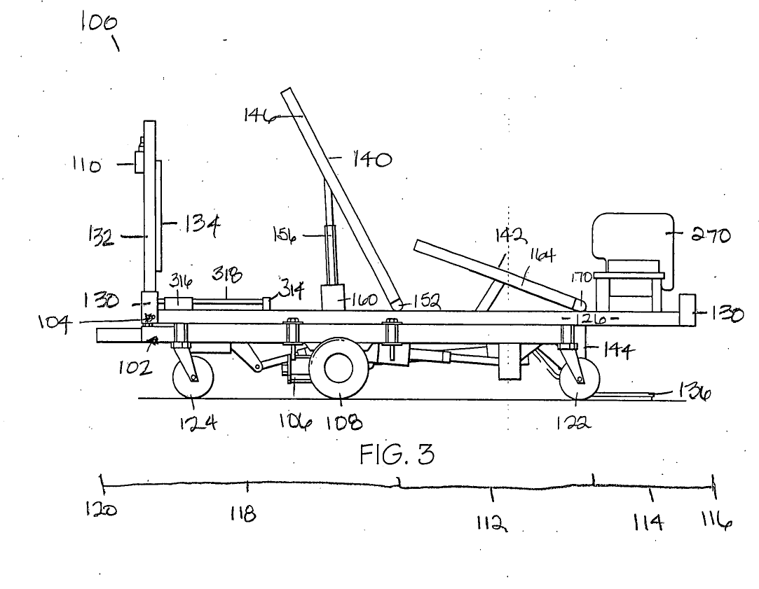

The articulating head support 140 has a perimeter frame 146, a center beam 148, and a plurality of support plates 150 spanning transversely to interconnect the frame 146 and beam 148. As shown in FIG. 3, pivotable motion of the articulating head support 140 relative to the base frame 102 is enabled by a pinned connection between a pair of brackets 152 extending from the perimeter frame 146 and a pair of bars 154 rigidly connected with the base frame back portion 118. A first actuator 156, preferably being a linear push-type actuator, has a pinned connection on one end with an actuator support plate 158 affixed to the center beam 148 of the articulating head support 140 and also has a pinned connection on an opposite end with an actuator fork 160 rigidly connected to a perimeter foundation member 162 extending transversely across back portion 118 of the base frame 102, thereby functioning through extension and retraction of actuator 156 to raise and lower the head and torso of a patient positioned on the assembly 104. It will be appreciated by those skilled in the art that, from its horizontal position, head support 140 may be raised up to an angled position of about a sixty degree angle.

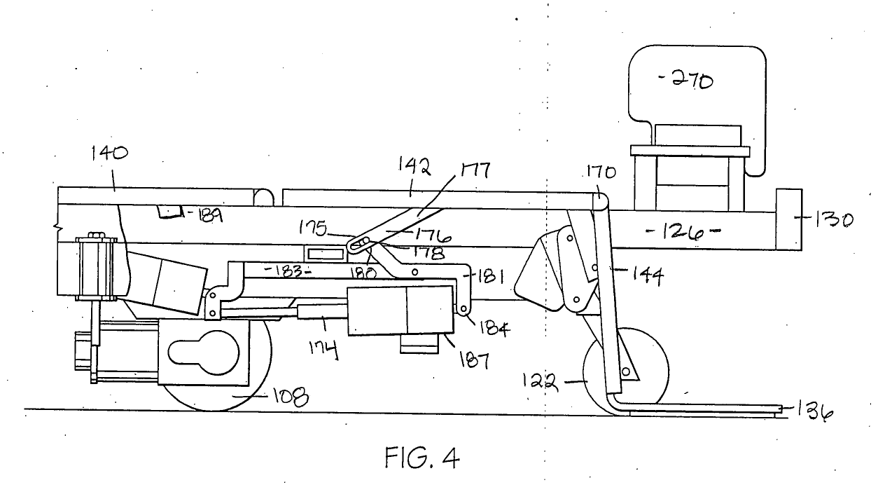

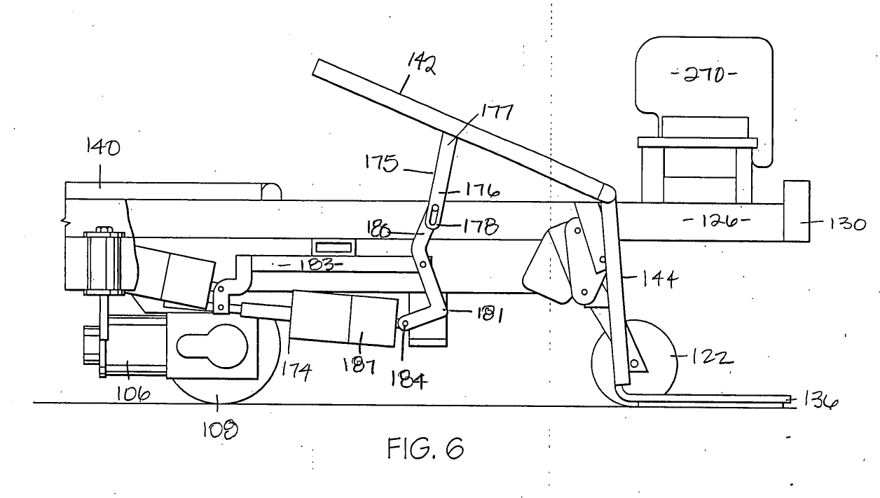

The articulating seat gatch or support 142 has a perimeter frame 164, a center beam 166, and a plurality of support plates 168 spanning transversely to interconnect the frame 164 and beam 166. Pivotable motion of the articulating seat support 142 relative to the base frame 102 is enabled by a pinned connection between a pair of brackets 170 extending from the perimeter frame 164 and a pair of bars 172 rigidly connected with the base frame center portion 112. A second actuator 174, preferably a pull-type linear actuator, in combination with a generally S-shaped linkage 175, best shown in FIGS. 4, 5 and 6, enables the seat support 142 to be pivotally raised and lowered. In particular, a pair of linkage bars 176 each have an upper end 177 pivotally connected to center beam 166 and a lower end 178 having a slot defined therein wherein lower end 178 is slidably connected to a first end 180 of a pair of generally S-shaped linkage mounting bars 181. Proximate first end 180, mounting bars 181 have a pinned connection with a longitudinal member 183 thereby creating a pivot point. A second end 184 of mounting bars 181 has a pinned connection with second actuator fork 187 that is rigidly coupled to longitudinal member 183. Thus, extension and retraction of second actuator 174 causes rotation of the S-shaped linkage 175 and corresponding movement of seat support 142 relative to the base frame 102 thereby raising and lowering the lower torso and upper legs of a patient positioned on the assembly 104 up to about a twenty degree angle from its horizontal position. In one embodiment, a safety switch 189 mounted on the underside of head support 140 is configured to prevent the activation of second actuator 174 if head support 140 is not in its angled position thereby preventing the seat support 142 from being raised without head support 140 being raised first.

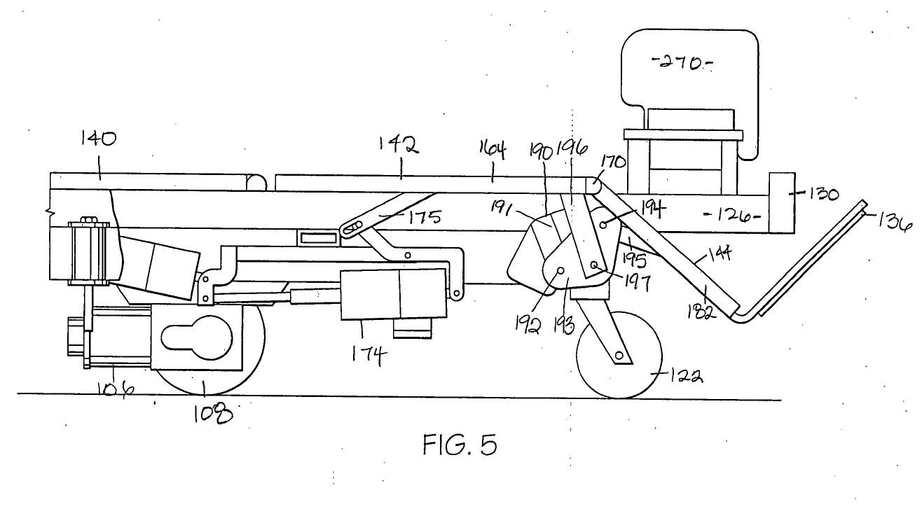

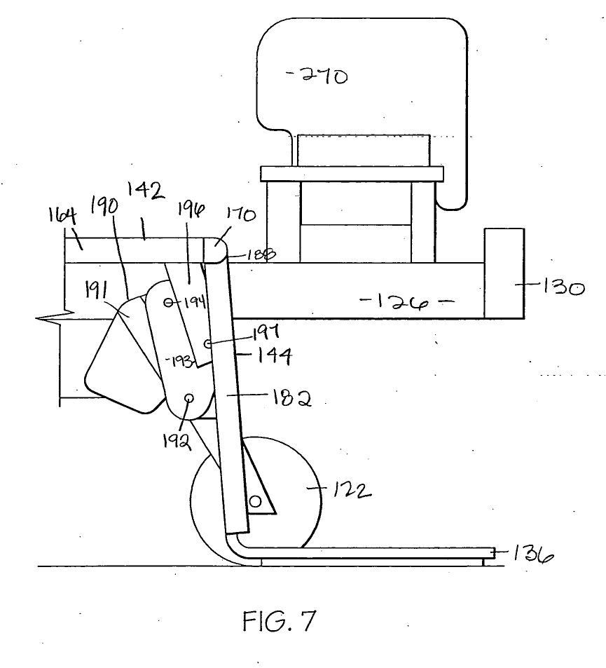

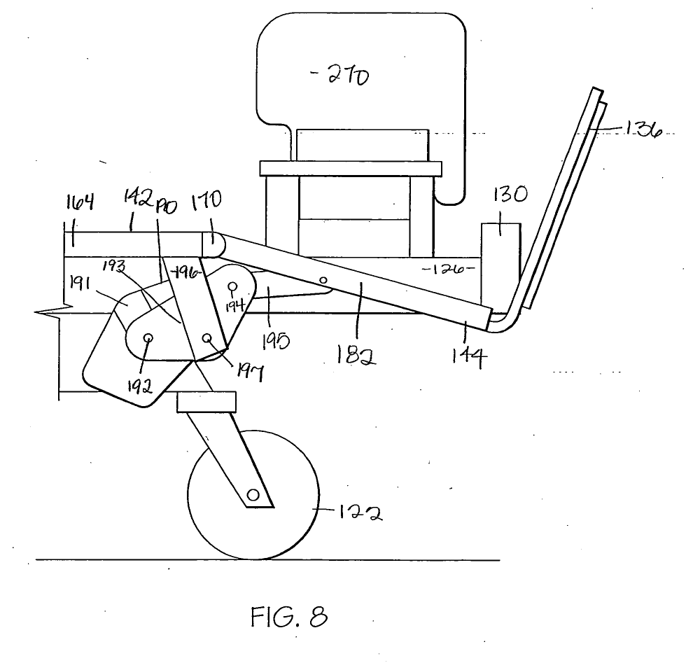

As seen in FIGS. 5-8, the articulating foot gatch or support 144 has a perimeter frame 182 and a plurality of support plates 184 spanning transversely to interconnect portions of the frame 182. Foot support 144 also has at least one longitudinal beam 186 perpendicular to the support plates 184 and interconnecting portions of the frame 182. A pinned connection is implemented between brackets 170 extending from the perimeter frame 164 of the seat support 142 and a pair of bars 188 rigidly connected with the perimeter frame 182 of the foot support 144. A third actuator 190, preferably a pull-type rotary actuator, has a pinned connection on one end with a pair of actuator support bars 191 that are pivotally connected to a first pivot point 192 of a generally triangular support plate 193. A second pivot point 194 is pivotally connected to one end of a pair of rigid members 195 extending downwardly from and pivotally connected at the other end to each of the longitudinal members of perimeter frame 182. A pair of fixed members 196 rigidly connected to each of the longitudinal members 126 extend downwardly and pivotally connect with a third pivot point 197 on support plates 193 thereby functioning through retraction and extension of actuator 190 to raise and lower the legs as well as cause bending of the legs at the knees of a patient positioned on the assembly 104.

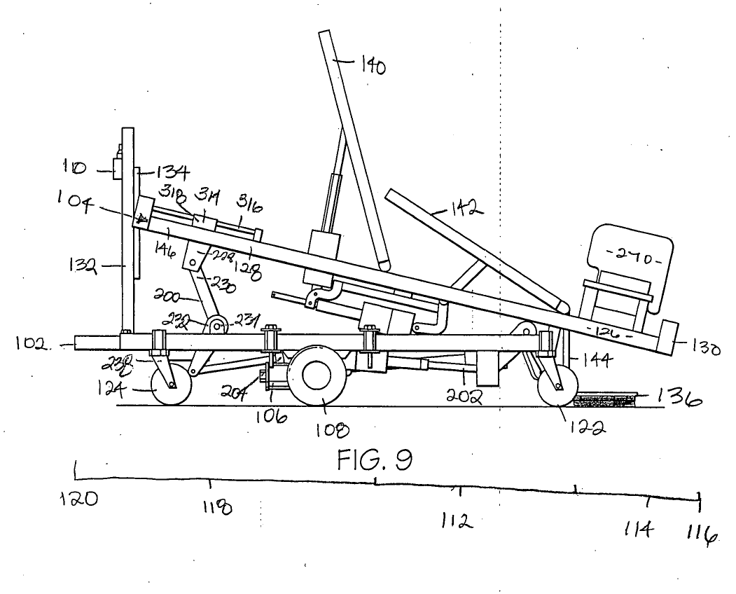

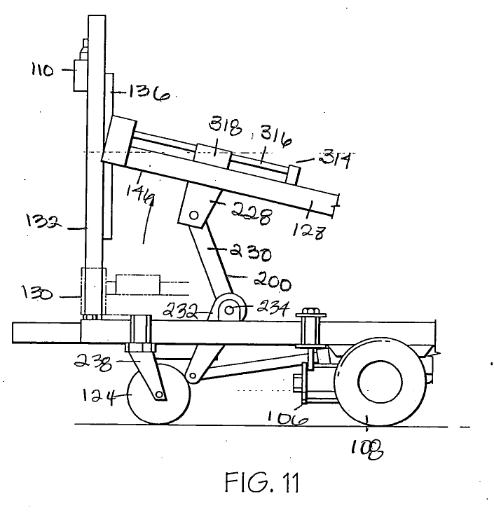

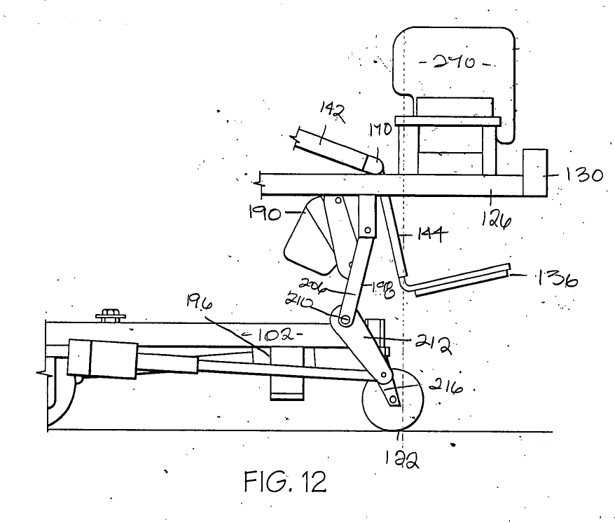

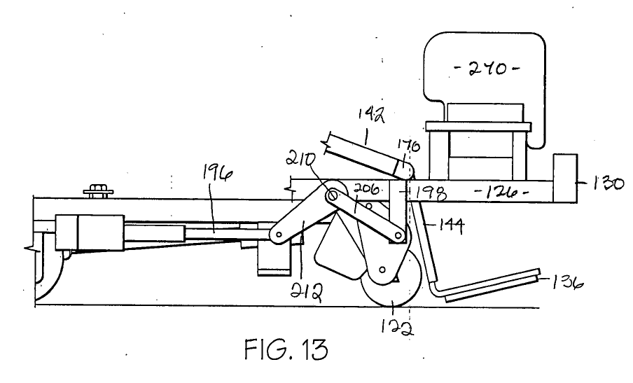

Turning to FIGS. 9-13, a leading high-low linkage 198 and a trailing high low linkage 200 are provided for coupling the leading stabilizing wheels 122 and trailing stabilizing wheels 124, respectively, to the base frame 102. In combination with a fourth actuator 202 and a fifth actuator 204, the leading and trailing high low linkages 198, 200 serve to raise and lower the bed 100 relative to an underlying surface. Raising of the bed 100 may be desired when a worker needs better access to the patient to examine them or perform other tasks.

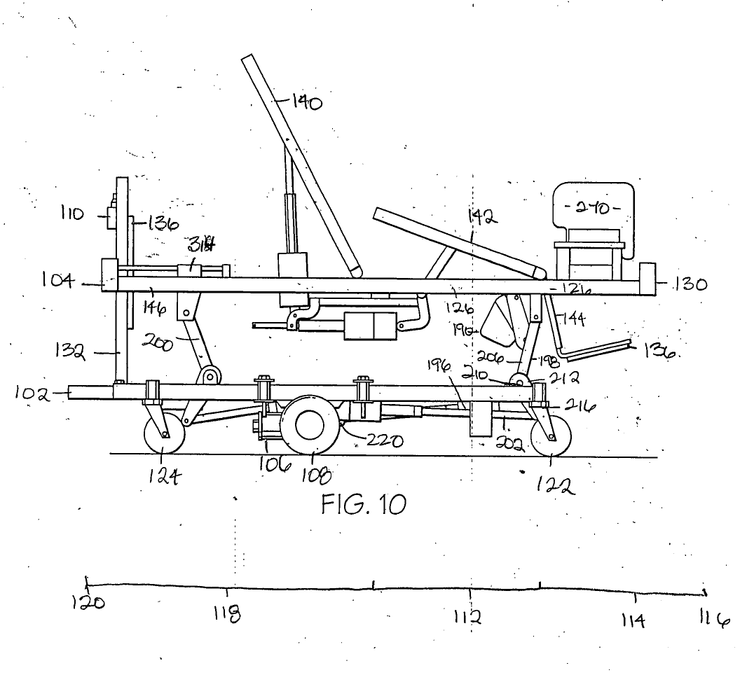

Raising and lowering of the forward portion 114 of the bed 100 may be accomplished with the following structure coupled with the leading high-low linkages 198 and best seen in FIGS. 9 and 10. A pair of linkage bars 208 are rigidly connected with the longitudinal members 126 overlying base frame forward portion 114. The leading high-low linkages 198 each have an upper end 208 pivotably connected with one of the linkage bars 206 and a lower end 210 pivotably connected with a vertical flange 212 extending from a horizontal brace 214 interconnecting a pair of mounting bars 216. Each mounting bar 216 is adapted for having mounted therewith one of at least two leading stabilizing wheels 122. A pair of horizontal support members 218 span between the high-low linkages 198 and serve to transfer forces from a fourth actuator 202 to the linkages 198. The fourth actuator 202 has a first pinned connection with an actuator fork 220 rigidly connected to the perimeter foundation member 196 of the base frame forward portion 114 adjacent actuator fork 194 of the third actuator 190, and a second pinned connection with an actuator support member 222 mounted on the horizontal support members 218. Thus, extension and retraction of the fourth actuator 202 causes rotation of the leading high-low linkages 198.

Likewise, raising and lowering of the back portion 118 of the bed 100 may be accomplished with the following structure coupled with the trailing high-low linkages 200. A top end of a pair of linkage bars 228 extend through members 126 are coupled to a block 318 that is slidably connected to a rod 316 of a slider block mechanism 314 fixedly attached to the top of head support perimeter frame 146. Slider block mechanism 314 allows linkages 198 and 200 to move and equalize within their ranges of travel as actuators 202 and 204 (described below) are activated. The trailing high-low linkages 200 each have a proximal end 230 pivotably connected with one of the linkage bars 228 and a distal end 232 pivotably connected with a vertical flange 234 extending from a horizontal brace 236 interconnecting a pair of mounting bars 238. Each mounting bar 238 is adapted for having mounted therewith one of the trailing stabilizing wheels 124. A pair of horizontal support members 240 span between the high-low linkages 200 and serve to transfer forces from the a fifth actuator 204 to the linkages 200. The fifth actuator 204 has a first pinned connection with an actuator fork 242 rigidly connected to horizontal brace 236 adjacent actuator fork 160 of the first actuator 156, and a second pinned connection with an actuator support member 244 mounted on the horizontal support members 240. Thus, extension and retraction of the fifth actuator 204 causes rotation of the trailing high-low linkages 200 to raise and lower the back portion of patient support assembly 104. Additionally, a bracket system 224 may be used to secure batteries 226 in place for providing electrical power to the control system 110, as will be explained in more detail below.

In another embodiment of the bariatric bed 100 of the present invention, a scale system (not shown) may be incorporated into linkages 198 and 200 wherein a load cell (not shown) is affixed to each corner of patient support assembly 104 and is electrically connected to a scale head (not shown) to accurately weigh the load supported by patient load assembly 104.

In use, a bariatric patient may be easily maneuvered into a standing position by first raising linkage 200 to its highest point thereby raising the back portion 118 of patient support assembly 104 and also lowering linkage 198 thereby lowering forward portion 114 toward the floor. Next, head support 140 is raised to its full angled position to assist the patient into a sitting position. Foot support 144 is then lowered so that footplate 136 rests horizontally on the floor and seat support 142 is then raised to its full angled position. Through the combined support of the raised back portion 118, lowered forward portion 114, raised head support 140, raised seat support 142, and lowered foot support 144, the patient is able to achieve a full standing position on footplate 136 with little to no assistance from others (e.g., health care workers).

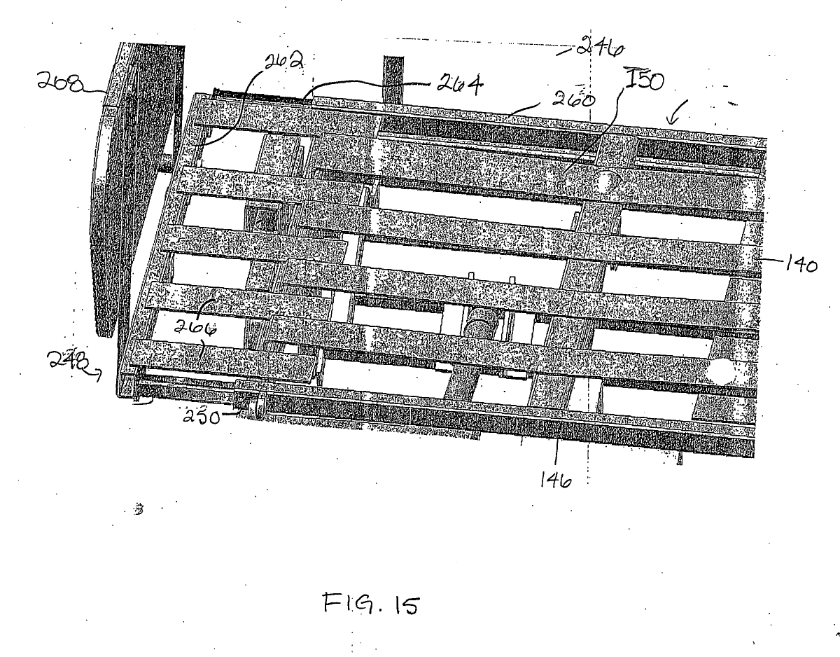

Referring now to FIG. 15, in another embodiment of the bariatric bed 100 of the present invention, frame extensions 246 are implemented for selectively increasing the width of the articulating head support 140 and articulating seat support 142 of the patient support assembly 104. This allows for a broader range of patients of varying widths to fit on the bed 100 while allowing the patient support assembly 104 to be narrowed when necessary to pass, for example, through a narrow hall or doorway.

In this embodiment of the bariatric bed 100, a set of head support extensions 248 are configured to be slidably received within opposing ends of transverse sleeves 250 of the perimeter frame 146 of the articulating head support 140. Each head support extension 248 includes a longitudinal channel member 252 having transverse end members 254 extending from opposing ends thereof for being received into the transverse sleeves 250. Additionally, support plate extensions 256 extend on one end from the longitudinal channel member 252 and terminate at a free end. The support plate extensions 256 are alternately positioned with respect to the support plates 150 of the articulating head support 140, and have a length sufficient to allow the free end thereof to rest upon on the perimeter frame 146 while the transverse end members 254 slide within the transverse sleeves 250 for proper support of a patient on the support plate extensions 256. Upon continued outward movement of the longitudinal channel member 286 away from the articulating head support 140, the transverse end members 254 will slide out of the transverse sleeves 250, thereby separating the respective head support extension 248 from the bed 100.

A set of seat support extensions 256 are configured to be slidably received within opposing ends of transverse sleeves 260 of the perimeter frame 164 of the articulating seat support 142. Each seat support extension 258 includes a longitudinal channel member 262 having transverse end members 264 extending from opposing ends thereof for being received into the transverse sleeves 260. Support plate extensions 266 are also included on each seat support extension 258 and span on one end from the longitudinal channel member 262 and terminate at a free end. The support plate extensions 266 are alternately positioned with respect to the support plates 168 of the articulating seat support 142, and have a length sufficient to allow the free end thereof to rest on the perimeter frame 164 while the transverse end members 264 slide within the transverse sleeves 260 for proper support of a patient on the support plate extensions 266. Upon continued outward movement of the longitudinal channel member 262 away from the articulating seat support 142, the transverse end members 264 will slide out of the transverse sleeves 260, thereby separating the respective seat support extension 258 from the bed 100.

The head support extensions 248 may also have head area sideboards 268 preferable movably connected therewith. The foot support 144 may also have foot area sideboards 270 connected therewith. The head area sideboards 268 and foot area sideboards 270 cooperate to block the patient from moving laterally off of the patient support assembly 104. The head area sideboards 268 are pivotably mounted to the head support extensions 248 by a pair of bars 272 pivotably coupled on first ends thereof with the one of the longitudinal channel members 252 and on second ends thereof with the corresponding head area sideboard 268. The foot area sideboards 270 are affixed to the forward ends 116 of longitudinal members 126. Head area sideboard 268 and foot area sideboard 270 may be rotated downward to a position substantially below a corresponding plane formed by the top of a mattress (not shown) to enable access to the patient by an operator (e.g., health care worker) and/or to remove the patient from the bed 100.

Suitable selectively usable stops or locks may be provided to fix the extensions 248 and 258 in pre-selected sideways extended or retracted positions or pivoted positions. A suitable stop for extension could be a pin with a spring loaded detent such as a hitch pin receivable in aligned apertures 276 and 278 in the sleeves 250 and 260 and transverse end members 254 and 264.

The drive assembly 106 includes a drive motor means 280 preferably having axially aligned initial outputs extending in opposite directions, a gear box 282 coupled with each output, and an output shaft 284 extending from each of the gear boxes 282 such that the dual output shafts 284 are also preferably axially aligned and extending in opposite directions for mounting of the drive wheels 108 thereon. The gear boxes 282 convert the rotational rate (angular velocity) of the initial outputs of the drive motor means 280 to an output shaft rotational rate (angular velocity) that is appropriate for propelling the transport over a range of desired rates speeds and directions. One suitable drive assembly 106 that may be implemented (with drive wheels 108) is the powered axle drive assembly disclosed in U.S. Pat. No. 6,727,620, issued to White et al., and entitled “Apparatus and Method for a Dual Drive Axle”, the teachings of which are incorporated herein by reference. The powered axle drive assembly of the '620 patent provides a unitary unit that may serve as the drive assembly 106 with the drive motor means 280 presenting the initial outputs as being independently controlled by separate rotor assemblies such that the final output shafts 284 rotate each drive wheel 108 in a direction and with a rotational speed that is independent of the rotation of the other drive wheel 108. The drive wheels 108 are preferably gel filled tires or solid tires that require less maintenance than pneumatic air filled tires.

Preferably, the drive assembly 106 is disposed longitudinally along the base frame 102 of the bed 100 proximal to the center portion 112 thereof, and laterally such that the central longitudinal axis of the base frame 102 bisects the drive assembly 106 with the drive wheels 108 positioned approximately equidistant from the central longitudinal axis. This helps with balance and allows the bed 100 to turn in either direction on an underlying surface or floor essentially in position with little or no lateral movement across the surface (i.e., with as short a turning radius as is reasonable or possible). Short turning radiuses are highly desirable particularly when the bed 100 is in tight spaces or when a sharp turn (e.g., 90 degrees or more) needs to be made.

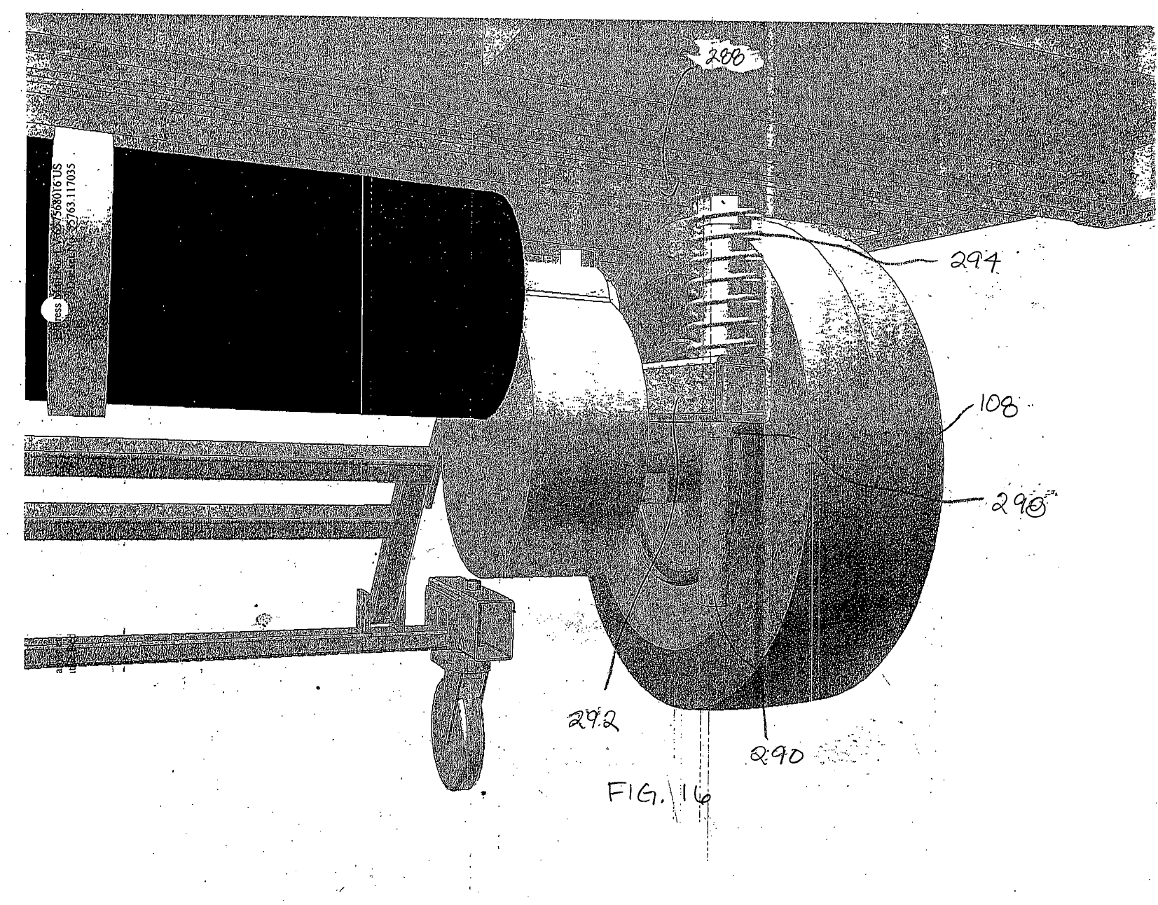

Referring now to FIG. 16, coupling of the drive assembly 106 to the base frame 102 is preferably accomplished by suspending the drive assembly 106 from the frame 102 with a mounting apparatus 286. The mounting apparatus 286 ensures that the drive wheels 108 maintain contact with the surface as the surface has transition points in slope where not all of the drive wheels 108, leading stabilizing wheels 122 and trailing stabilizing wheels 124 would normally contact the underlying surfaces and can each pivot about their own axis. One example of this is when the bed 100 is moving between a ramp and a generally flat surface where at some points only the leading and trailing stabilizing wheels 122, 124 (and not the drive wheels 108) would be contacting the ramp or surface if all the wheels were mounted without mounting. The mounting apparatus 286 gives the drive wheels 108 a range of motion generally perpendicular to the direction of movement of the transport across a surface.

The mounting apparatus 286 includes a set of components 288 mounted proximal to each of the drive wheels 108. Each component set 288 includes a pair of mounting rods 290 extending downwardly from the perimeter foundation member 180 of the base frame center portion 112, a stabilizing bar 292 interconnecting the mounting rods 290 together, and a pair of compression springs 294 managing vertical displacement of the drive assembly 106 relative to the base frame 102. The stabilizing bar 292 is rigidly connected to a collar 296 of the drive assembly 106 enclosing the respective output shaft 284 and near opposing ends thereof has vertically oriented bores through which one pair of mounting rods 290 extends. Bushings 298 may be provided and fitted around the mounting rods 290 and fixedly within the bores to facilitate sliding movement of the rods 290 axially through the bores. The springs 294 are fitted around the mounting rods 290 and are seated on a lower end thereof on the upper surface of the stabilizing bar 292 and on an upper end thereof against the base frame center portion 112. Springs 294 are selected with physical properties that provide extension and thus downward movement of the drive assembly 106 along the mounting rods 290 when a negative transition or concave surface feature is reached by the drive wheels 108 (e.g., between a flat surface and an upwardly sloping incline or ramp) to maintain the wheels 108 in contact with the surface feature, and provide compression and thus upward movement of the drive assembly 106 along the mounting rods 290 when a positive transition or convex surface feature is reached by the drive wheels 108 (e.g., at the crest of a hill) to maintain the leading and trailing stabilizing wheels 122, 124 in contact with the surface feature. Additionally, the dual mounting feature—providing the sets of components 288 near each of the drive wheels 108—aids in maintaining drive wheel 108 contact with the underlying surface when uneven terrain or surface features are reached which affect the wheels independently (e.g., uneven terrain, curb drop-offs, hitting a ramp other than “square” or such) or when the bed 100 has uneven lateral weight distribution based on the patient or equipment placed upon the transport. Although two separate motor means 280 are shown, a single motor 280 may be used and can be used to drive both wheels 108 independently as for example through a series of clutches and drive elements.

The control system 110 includes, in one embodiment, a control module 300 and an input device 302. The control module 300 is electrically coupled with the drive motor means 280 and with the input device 302. If desired, the control module 300 and input device 302 may be integrated together into a single unit; however, it is preferable that the control module 300 and device 302 be separate units to reduce the distance between the drive motor means 280 and the control module 300 supplying electrical power thereto, reducing power loss. One or more batteries 226, preferably two, supply electrical power for the control system 110. Preferably, the batteries are of the rechargeable type. Preferably, the control module 300 has a number of input and output leads to which the drive motor means 280, input device 302 and batteries 226 are connected through wiring or cabling (not shown). Additionally, one location where the control module may be mounted is onto the perimeter foundation member 180 of the base frame center portion 112. A battery charger may be mounted, for example, on headboard 134 and has the necessary cabling for supplying power from a typical A/C electrical outlet to the batteries 226.

One suitable control module 300 and input device 302 combination is the SHARK model controller arrangement of Dynamic Controls, Christchurch, New Zealand. The control module 300 provides circuitry in the form of a compact module with a protective housing, and further operates in a so-called “dual mode” fashion so that the control module 300 may communicate with the input device 302 (e.g., by receiving input signals from the device 302) as well as supply electrical power thereto. In this way, the batteries 226 do not have to supply electrical power directly to the input device 302, but only through the control module 300 to the input device 302 when it is needed. This arrangement reduces the amount of power cabling needed in the control system, as such cabling does not have to be extended to the input device 302. Alternatively, the control module 300 and input device 302 may be in the form of a single integrated controller residing in a single housing and receiving power directly from the batteries 226.

The control system 110 may be configured to operate on 24 volt DC power such that the pair of batteries 226 are preferably each a deep cycle 12 volt DC type battery. Additionally, the batteries 226 are ideally a type of battery that does not require water or is otherwise sealed so that the tilting of the battery to various positions when the transport is in a folded state for storage or moving into a narrow area does not result in spillage of battery contents. For example, the batteries 226 may be gel filled or a sealed lead acid battery. Additionally, circuit breakers may be provided with the batteries when excessive current is being drawn by the components of the control system 110 and/or drive assembly 106.

The control module 300 includes in one embodiment, within a housing 304, a processor (e.g., microprocessor, microcontroller or application-specific integrated circuit) for receiving inputs from the input device 302 or other devices (e.g., a speed sensor measuring the rate of rotation of the drive wheels 108) and managing the amount of electrical power supplied through outputs to the drive motor means 280, and a memory device for storing program code or other data. A current reversing device, such as one or more relays, may also be provided in the control module 300 to control the direction of current flow supplied to the drive motor means 280. By controlling the supply of electrical power in accordance with operator input received on the input device 302, and optionally, with sensed rotational speed of each drive wheel 108, the control module 300 regulates the amount of power output of the drive motor means 280 for each output shaft 284. Similarly, based on the operator input received on the input device 302 (i.e., direction of travel for the bed 100), the control module 300 determines the direction of current flow supplied to each output shaft 284 of the drive motor means 280 to cause drive wheel 108 rotation in a desired direction. For instance, if a measured speed of rotation of the drive wheels 108 is less than a speed of travel for the transport selected on the input device 302, such as when the bed 100 encounters resistance from gravity when traveling up a ramp, the control module 300 will draw more current from the battery 226 to the drive motor means 280 to produce more motive power.

The input device 302 is configured to generate a signal based on the input received from an operator and transmit the signal to the control module 300 to control drive motor means 280 operation. Preferably, the input device 302 includes a housing 306, a joystick lever 308 mounted with the housing for accepting operator inputs regarding a direction of travel or rotation for the bed 100, a rotatable speed control knob 310 mounted with the housing 306 for selecting a speed of travel/rotation, and circuitry (not shown) to process the input received through lever 308 and knob 310 and generate a command signal for transmission to the control module 300. The joystick lever 308 may be positioned in a generally vertical orientation when in a neutral position but may also be positioned in various neutral position orientations by moving the control module to other orientations. For example, the joystick lever 308 may be generally horizontal in neutral. The circuitry for the input device 302 may include a processor and memory device similar to that of the control module 300. The input device 302 may also include an LED display (not shown) providing a visual indication of different operating conditions of the device 302 and a horn (not shown). Also, the input device 302 is preferably mounted on a lateral member 312 extending from one of the risers 132 of the base frame back end 120 proximal to and below one of the handles 120 or may be mounted directly to headboard 134 in-line with bed 100. This allows the joystick lever 308 and other input capturing means on the device 302 to be easily reached by the operator guiding the transport movement without completely removing their hand from the handle 138. The input device 302 may be programmed to customize how certain movements of the joystick lever 308 will generate command signals for transmission to the control module 300 regulating current flow to the drive motor means 280.

The drive assembly 106 may be configured to accomplish braking (optionally with assistance from the control system 110) according to three different schemes: regenerative, dynamic and static friction braking. For regenerative braking, when the sensed speed of rotation of the drive wheels 108 exceeds the speed of the transport selected on the input device 302, such as when the bed 100 is traveling down an incline, the drive motor means 280 switches to electrical generation mode to recharge the batteries 226. Dynamic braking is engaged when the joystick lever 308 is released by the operator and returns to the neutral center position, and works to create an electrical short in the drive motor means 280 that prevents rotation of the drive wheels 108. Static friction breaking involves compression of a break pad with a component of the drive assembly 106 (e.g., wheels 308 or output shafts 306), and aids in maintaining the bed 100 at a stop when the same is on, for example, and incline where “creep” may result from utilizing dynamic breaking alone. Another embodiment of a suitable drive assembly, control assembly and mounting apparatus is shown in pending U.S. patent application Ser. No. 11/167,990, filed Jun. 27, 2005, entitled “Bariatric Transport with Improved Maneuverability,” the teachings of which are hereby incorporated by reference to the extent permitted by law.

From the foregoing, it may be seen that the bariatric bed of the present invention displaying increased ease in allowing a patient to exit the foot of the bed over prior designs is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A multipositional bariatric bed adapted for supporting a patient thereon comprising:
a base frame having a forward portion, a center portion, and a back portion;
an articulating head support overlying said back portion of said base frame and extending generally toward a back end of the bed away from the center portion of the base frame and a free end configured to move generally vertically relative to said base frame in at least one pivoted position of the head support, the head support having a first surface formed thereon;
an articulating seat support overlying said center portion extending generally toward a back end of said center portion and a free end configured to move generally vertically relative to said base frame in at least one pivoted position of said seat support, said seat support having a second surface formed thereon;
an articulating foot support overlying said forward portion of said base frame and extending generally toward the front end of said forward portion and a free end configured to move downwardly relative to said base frame in at least one pivoted position of the articulating foot support, the articulating foot support having a third surface formed thereon; and
at least one actuator for pivoting said head support, seat support, and foot support relative to said base frame;
wherein said first, second and third surfaces are adapted to support a patient thereon.

2. The multipositional bariatric bed of claim 1, said forward portion extending from said center portion to a forward end said back portion extending from said center portion to a back end opposite said forward end wherein said forward portion, said center portion and said back portion are formed of spaced longitudinal members and a longitudinally-spaced transverse member affixed to and extending thereacross proximate said back end.

3. The multipositional bariatric bed of claim 2, said transverse member having at least one sleeve with a solid bottom affixed thereto for removable insertion of at least one riser therein and said spaced-longitudinal members each having at least one sleeve with a solid bottom affixed at the ends thereof in an opposite direction from said transverse member for removable insertion of at least one riser therein.

4. The multipositional bariatric bed of claim 3, further comprising a headboard removably mounted to said at least one riser at said back end and a footplate affixed to said foot support at said forward end.

5. The multipositional bariatric bed of claim 4 wherein said at least one riser defines a handle at terminal ends thereof.

6. The multipositional bariatric bed of claim 1, said head support further comprising a perimeter frame, a center beam, and a plurality of support plates spanning transversely to interconnect said frame and said beam.

7. The multipositional bariatric bed of claim 6, said head support further comprising head support extensions for selectively increasing the width of said head support.

8. The multipositional bariatric bed of claim 1, said seat support having a perimeter frame, a center beam, and a plurality of support plates spanning transversely to interconnect said frame and said beam.

9. The multipositional bariatric bed of claim 8, further comprising a generally S-shaped linkage operably coupled to said center beam at one end and to said second actuator at the opposite end for raising and lowering said seat support.

10. The multipositional bariatric bed of claim 8, further comprising a safety switch for preventing activation of said second actuator when said head support is not in said angled position.

11. The multipositional bariatric bed of claim 1, said foot support further comprising a perimeter frame a plurality of support plates spanning transversely to interconnect portions of said frame and at least one longitudinal beam perpendicular to said support plates and interconnecting portions of said frame.

12. The multipositional bariatric bed of claim 11, further comprising a foot support linkage operably coupled at one end to said foot support and to said third actuator at the opposite end for raising and lowering said foot support.

13. The multipositional bariatric bed of claim 1 further comprising:
a. a first high-low linkage coupled with the base frame forwardly of the center portion of the base frame;
b. wherein coupling of the leading stabilizing wheels with the base frame is accomplished by mounting the leading stabilizing wheels with the first high-low linkage;
c. a second high-low linkage coupled with the base frame rearwardly of the center portion of the base frame;
d. wherein coupling of the trailing stabilizing wheels with the base frame is accomplished by mounting the trailing stabilizing wheels with the second high-low linkage; and
e. wherein the first and second high-low linkages are each coupled with actuators to raise and lower said head support, seat support, and foot support while the leading and trailing stabilizing wheels are contacting the underlying surface.

14. The multipositional bariatric bed of claim 13 further comprising a scale system coupled to said linkages for measuring the weight of a load upon said first, second and third surfaces.

15. The multipositional bariatric bed of claim 13 further comprising a slider block mechanism for equalization of said linkages.

16. The multipositional bariatric bed of claim 13, said seat support further comprising seat support extensions for selectively increasing the width of said seat support.

17. The multipositional bariatric bed of claim 1 further comprising a drive assembly including at least one drive motor, first and second drive means connected to the at least one drive motor, and a pair of drive wheels, each wheel adapted to be independently rotatably actuated by said first or second drive means for steering.

18. The multipositional bariatric bed of claim 1 further comprising a control system adapted for controlling operation of the drive assembly in response to operator input received by the control system, and a portable electrical power source for supplying electrical power for operation of the drive assembly and the control system, wherein the control system and drive assembly together enable driving and steering of the bariatric bed transport in a variety of directions across an underlying surface with support from the at least one stabilizing wheel.

19. A multipositional bariatric bed adapted for supporting a patient thereon comprising:
a patient support assembly upon which the patient may be positioned;
means for pivotally raising and lowering said patient's head and upper torso;
means for pivotally raising and lowering said patient's lower torso and upper legs; and
means for pivotally lowering and raising said patient's legs and feet.

20. A method for raising a bariatric patient to a standing position comprising the steps of:
a. providing a bariatric bed having an articulating head support, an articulating seat support, and an articulating foot support;
b. raising said articulating head support to place said patient in a sitting position;
c. lowering said articulating foot support to allow said patient to exit said bed; and
d. raising said articulating seat support to place said patient in an upright position.
